(19) United States
(12) Patent Application Publication
(10) Pub. No.: US 2026/0071019 A1
(43) Pub. Date: Mar. 12, 2026

(54) NORBORNENE-DERIVED COPOLYMER, MANUFACTURING METHOD THEREOF AND METHOD FOR USING THE SAME

(71) Applicant: CPC Corporation, Taiwan, Kaohsiung City (TW)

(72) Inventors: Kao-Shu Chuang, Kaohsiung City (TW); Jyh-Chien Chen, Kaohsiung City (TW); Jhih-Wei Wu, Kaohsiung City (TW); Tse-Han Chiu, Kaohsiung City (TW); Jia-Hong Chen, Kaohsiung City (TW); Jui-Hsiung Huang, Kaohsiung City (TW)

(21) Appl. No.: 19/012,661

(22) Filed: Jan. 7, 2025

(30) Foreign Application Priority Data
Sep. 10, 2024 (TW) 113134287

(51) Int. Cl. C08F 232/08; B01J 41/05; B01J 41/14; B01J 47/12; C08J 5/22; C25B 13/08

(52) U.S. Cl. CPC C08F 232/08; B01J 41/05; B01J 41/14; B01J 47/12; C08J 5/2231; C25B 13/08; C08F 2810/20; C08J 2345/00

(57) ABSTRACT

Disclosed is a manufacturing method for a norbornene-derived copolymer, which includes several steps: a preparation step, a polymerization step, a precipitation step, a reduction step, a film formation step, and an ion exchange step. The preparation step involves creating a first solution of 5-(bromopropyl)bicyclo[2.2.1]hept-2-ene in anhydrous dichloromethane, a second solution of 5-butylbicyclo[2.2.1]hept-2-ene in anhydrous dichloromethane, and a third solution of [1,3-bis(2,4,6-trimethylphenyl)-2-imidazolinyl]dichloride(benzylidene)bis(3-bromopyridine)ruthenium(II) in anhydrous dichloromethane. The polymerization step involves mixing the first solution, the second solution, and the third solution using one of three methods: a first manner, a second manner, or a third manner.

### CROSS-REFERENCE TO RELATED APPLICATIONS

This disclosure claims priority under 35 U.S.C. § 119 to Taiwan Patent Application No. 113134287, titled “NORBORNENE-DERIVED COPOLYMER, MANUFACTURING METHOD THEREOF AND METHOD FOR USING THE SAME,” filed on Sep. 10, 2024, the disclosure of which is incorporated herein by reference in its entirety.

### FIELD OF THE INVENTION

The present invention relates to a manufacturing method of a norbornene-derived copolymer, and more particularly relates to a method for using the norbornene-derived copolymer in the field of anion exchange membrane water electrolysis as an anion exchange membrane.

### BACKGROUND OF THE INVENTION

Anion exchange membrane water electrolyzer (AEMWE) is one of the technologies that have been developing rapidly in recent years, in which an anion exchange membrane is used as an electrolyte, and hydrogen can therefore be produced efficiently with electrolyzing water.

Regarding an anion exchange membrane (AEM), previous studies have proposed using norbornene monomers derived from the Diels-Alder reaction to synthesize norbornene-based polymer through ring opening metathesis polymerization (ROMP), and subsequently reducing and using this polymer as an anion exchange membrane.

However, previous studies have shown that the synthesized polymer exhibited a high polydispersity index (PDI), indicating a significant variation in molecular weights among the molecules. This limitation hindered the accurate control of the sequence and length of different structural units in the polymer chains, and it was not feasible to synthesize block copolymers with exact structures. Using this product to manufacture anion exchange membranes could adversely affect several properties.

### SUMMARY OF THE INVENTION

In order to overcome the technical problems in prior art, the present invention provides a manufacturing method of a norbornene-derived copolymer, comprising: a preparation step of preparing an anhydrous dichloromethane solution of 5-(bromopropyl)bicyclo[2.2.1]hept-2-ene as a first solution, an anhydrous dichloromethane solution of 5-butylbicyclo[2.2.1]hept-2-ene as a second solution and an anhydrous dichloromethane solution of [1,3-bis(2,4,6-trimethylphenyl)-2-imidazoline]dichloro(phenylmethylene)bis(3-bromopyridine))ruthenium(II) as a third solution; a polymerization step of mixing the first solution, the second solution and the third solution at an active polymerization temperature and under a nitrogen atmosphere to cause a polymerization reaction, thereby obtaining an intermediate solution; a precipitation step of: adding ethyl vinyl ether to the intermediate solution, removing [1,3-bis(2,4,6-trimethylphenyl)-2-imidazoline]dichloro(phenylmethylene)bis(3-bromopyridine))ruthenium(II) by reduced pressure chromatography to obtain a filtrate, concentrating the filtrate under reduced pressure, and adding methanol to the concentrated filtrate to obtain a precipitate as a polymerization product; a reduction step of: dissolving the polymerization product in toluene, adding toluenesulfonylhydrazine, and stirring under nitrogen atmosphere to obtain a mixture, heating and refluxing the mixture to obtain a reduction intermediate solution, cooling the reduction intermediate solution with an ice-bath and filtering to remove excess toluenesulfonylhydrazine, performing Soxhlet extraction on the reduction intermediate solution with methanol, and obtaining a reduction product by vacuum drying an extraction product of the Soxhlet extraction; a film forming step of: preparing a 2% (w/v) chlorobenzene solution of the reduction product, adding N,N,N′,N′-tetramethyl-1,3-diaminopropane in an amount of 15% of the molar number of the terminal bromo group contained in the structure of the reduction product to obtain a mixed solution, filtering the mixed solution with a 0.22 m filter, casting the mixed solution on a flat container and heating to obtain a film-shaped product, and soaking the film-shaped product in a trimethylamine aqueous solution to performing quaternary ammonium saltation to obtain a quaternary ammonium saltation product, soaking the quaternary ammonium saltation product in deionized water, and vacuum drying the film-shaped product to obtain a cross-linked copolymer with film-shape; an ion exchange step of socking the cross-linked copolymer in a 1 M NaOH aqueous solution for 24 hours, and then rinsing the cross-linked copolymer with deionized water to obtain the norbornene-derived copolymer, wherein the polymerization step is performed in a first manner, a second manner or a third manner, the first manner is to simultaneously add and mix the first solution and the second solution to the third solution, the second manner is to sequentially add and mix the first solution and the second solution to the third solution, the third manner is to sequentially add and mix a portion of the first solution, the second solution, and the remaining portion of the first solution to the third solution, wherein the polymerization product obtained from the polymerization step performed in the first manner is represented by formula 1, the polymerization product obtained from the polymerization step performed in the second manner is represented by formula 2, the polymerization product obtained from the polymerization step performed in the third manner is represented by formula 3,

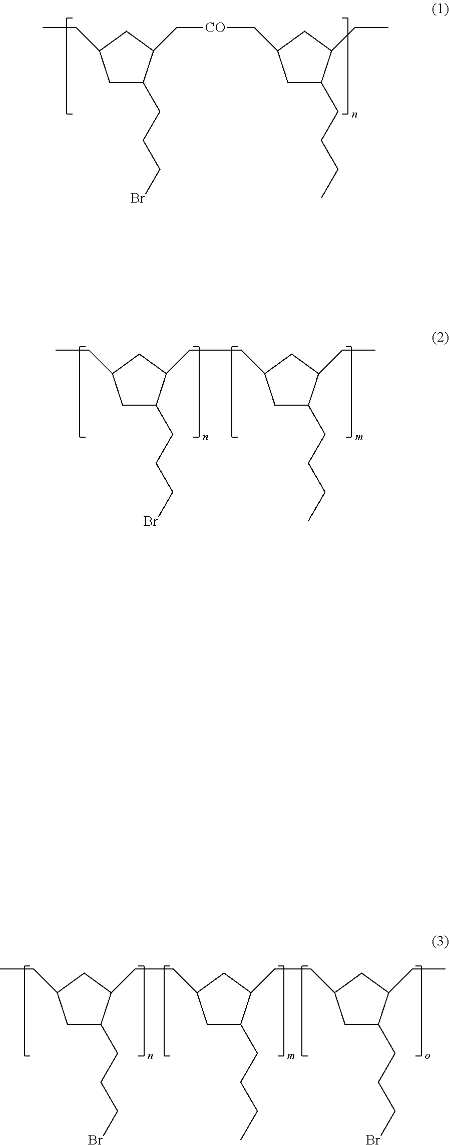

wherein when the polymerization step is performed in the first manner, the quaternary ammonium saltation product obtained in the film forming step is represented by formula 4, when the polymerization step is performed in the second manner, the quaternary ammonium saltation product obtained in the film forming step is represented by formula 5, when the polymerization step is performed in the third manner, the quaternary ammonium saltation product obtained in the film forming step is represented by formula 6,

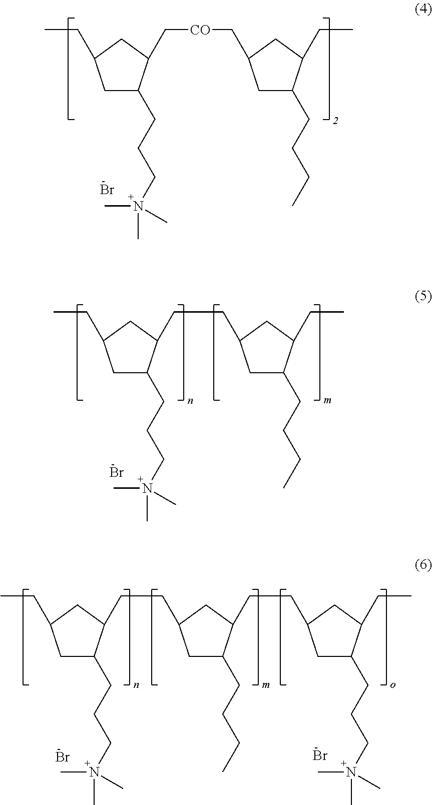

wherein when the polymerization step is performed in the first manner, the cross-linked copolymer obtained in the film forming step is represented by formula 7, when the polymerization step is performed in the second manner, the cross-linked copolymer obtained in the film forming step is represented by formula 8, when the polymerization step is performed in the third manner, the cross-linked copolymer obtained in the film forming step is represented by formula 9,

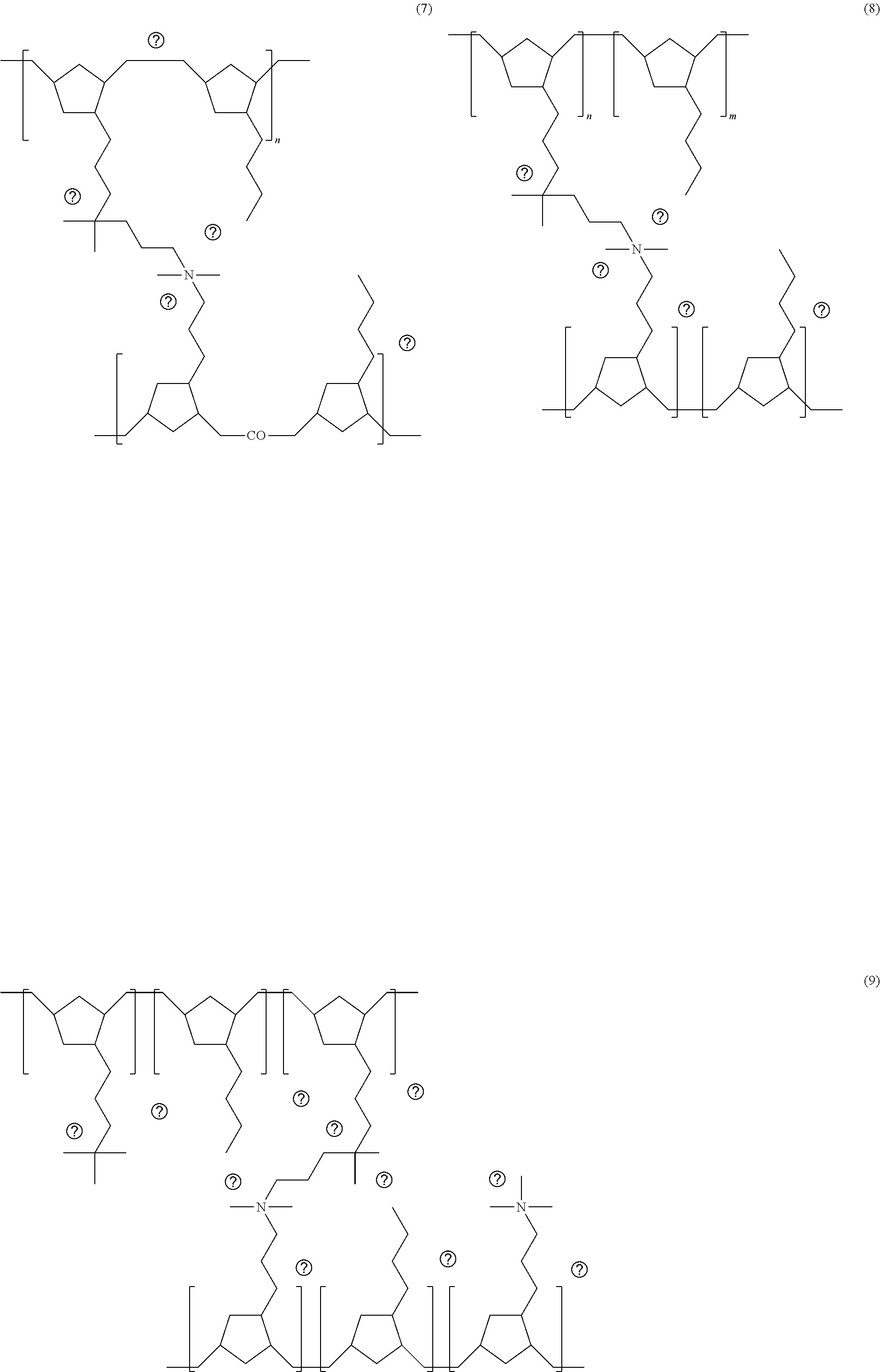

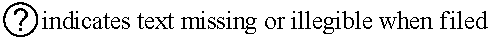

wherein when the polymerization step is performed in the first manner, the norbornene-derived copolymer obtained in the ion exchange step is represented by formula 10, when the polymerization step is performed in the second manner, the norbornene-derived copolymer obtained in the ion exchange step is represented by formula 11, when the polymerization step is performed in the third manner, the norbornene-derived copolymer obtained in the ion exchange step is represented by formula 12

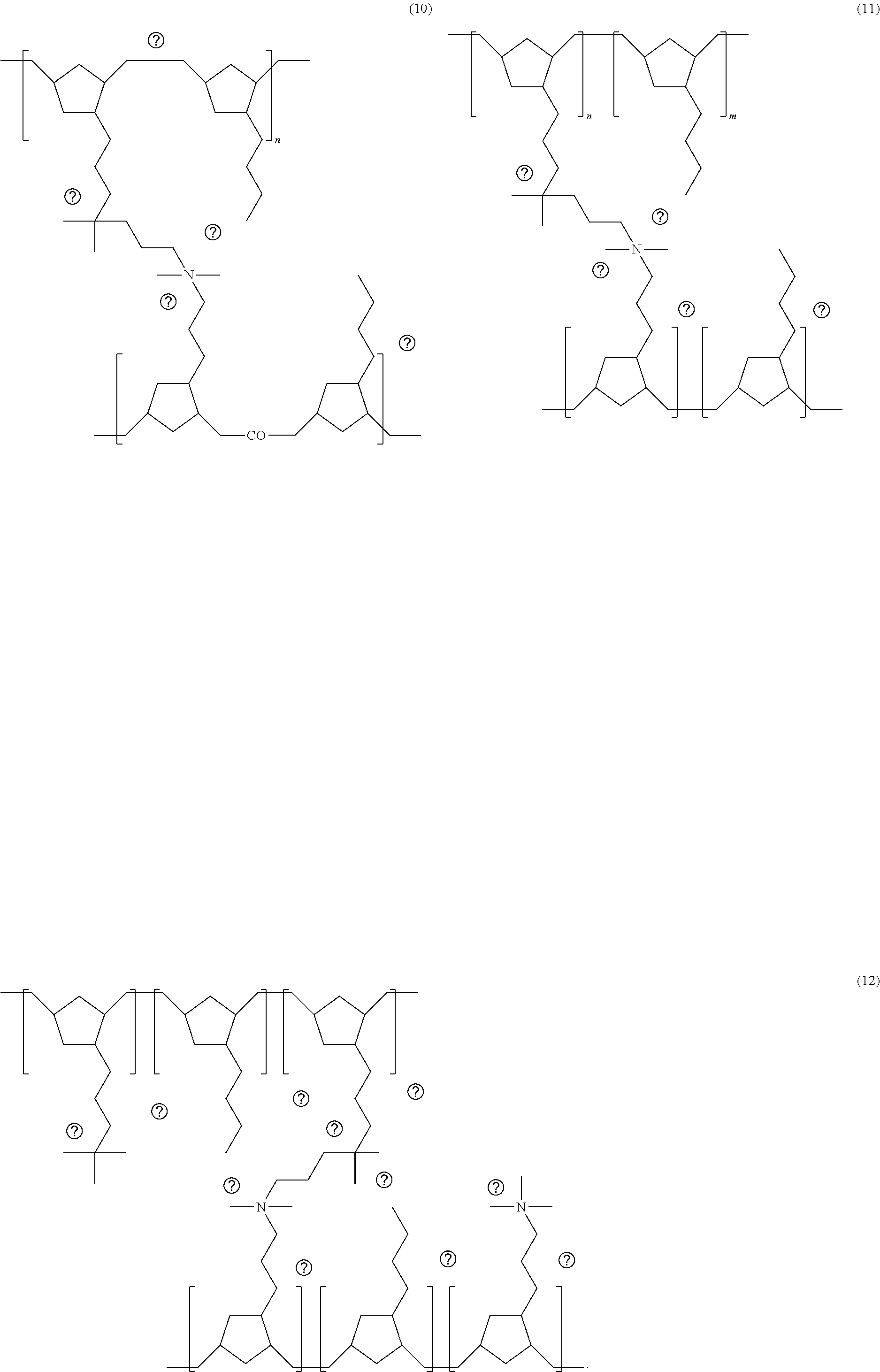

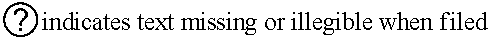

One embodiment of the present invention provides a manufacturing method, wherein in the preparation step, 1.44 mmol of 5-(bromopropyl)bicyclo[2.2.1]hept-2-ene is used to prepare 0.2M anhydrous dichloromethane solution as the first solution, and 2.20 mmol of 5-butylbicyclo[2.2.1]hept-2-ene is used to prepare 0.2M anhydrous dichloromethane solution as the second solution.

One embodiment of the present invention provides a manufacturing method, wherein the polymerization step is conducted at −26° C.

One embodiment of the present invention provides a manufacturing method, wherein in the third manner, the portion of the first solution and the remaining portion of the first solution added to and mixed with the third solution are of equal amounts.

The present invention provides a norbornene-derived copolymer manufactured by the manufacturing method described above.

The present invention provides a method for using the norbornene-derived copolymer described above, wherein the norbornene-derived copolymer is used in the domain of anion exchange membrane water electrolysis as an anion exchange membrane.

Through the technical methods employed in this invention, it is possible to obtain a norbornene-derived copolymer with a low PDI value, as well as an anion exchange membrane fabricated from this norbornene-derived copolymer.

### BRIEF DESCRIPTION OF THE DRAWINGS

FIG. 1 is a flow chart of a manufacturing method for a norbornene-derived copolymer according to an embodiment of the present invention;

FIG. 2 is a small-angle X-ray scattering spectrum of the norbornene-derived copolymer produced by the manufacturing method of the norbornene-derived copolymer according to an embodiment of the present invention;

FIG. 3 is a small-angle X-ray scattering spectrum of the norbornene-derived copolymer produced by the manufacturing method of the norbornene-derived copolymer according to another embodiment of the present invention;

FIG. 4 is a small-angle X-ray scattering spectrum of the norbornene-derived copolymer produced by the manufacturing method of the norbornene-derived copolymer according to another embodiment of the present invention; and

FIG. 5 is a transmission electron microscopy observation result of the norbornene-derived copolymer manufactured by the manufacturing method of the norbornene-derived copolymer according to another embodiment of the present invention.

### DETAILED DESCRIPTION OF THE PREFERRED EMBODIMENTS

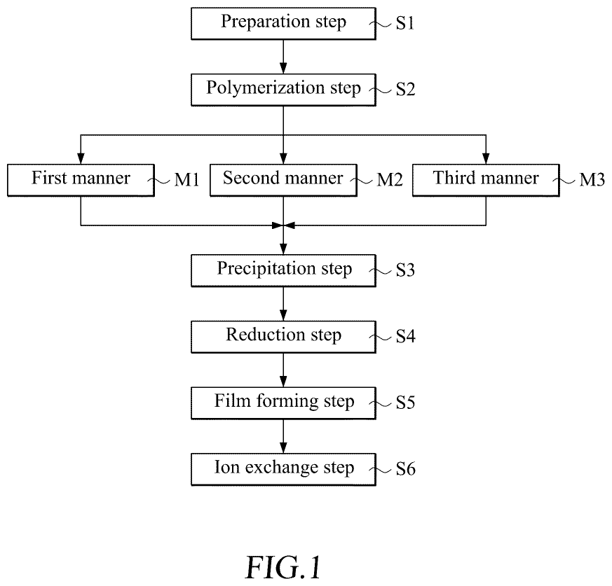

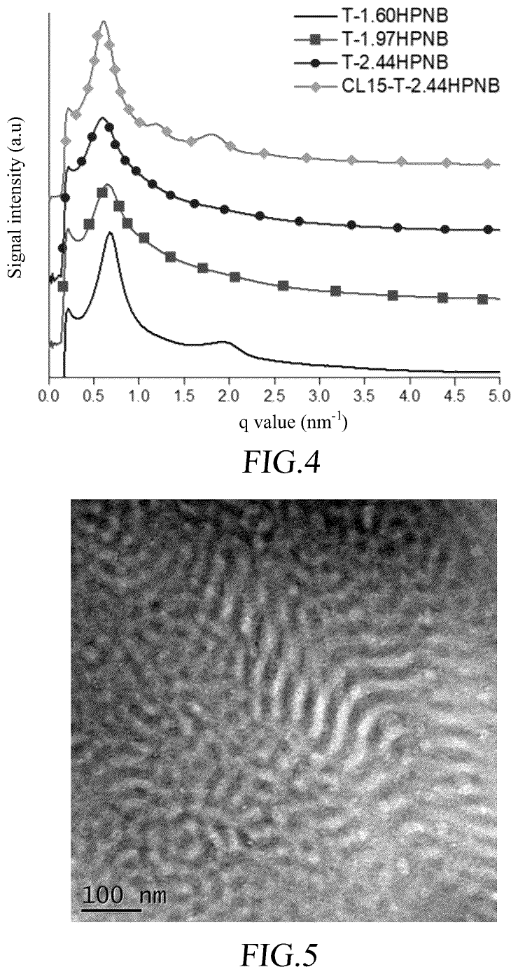

The preferred embodiments of the present invention are described in detail below with reference to FIG. 1 to FIG. 5. The description is used for explaining the embodiments of the present invention only, but not for limiting the scope of the claims.

A manufacturing method for a norbornene-derived copolymer, according to one embodiment of the present invention comprises: a preparation step of preparing an anhydrous dichloromethane solution of 5-(bromopropyl)bicyclo[2.2.1]hept-2-ene as a first solution, an anhydrous dichloromethane solution of 5-butylbicyclo[2.2.1]hept-2-ene as a second solution and an anhydrous dichloromethane solution of [1,3-bis(2,4,6-trimethylphenyl)-2-imidazoline]dichloro(phenylmethylene)bis(3-bromopyridine))ruthenium(II) as a third solution; a polymerization step of mixing the first solution, the second solution and the third solution at an active polymerization temperature and under a nitrogen atmosphere to cause a polymerization reaction, thereby obtaining an intermediate solution; a precipitation step of. adding ethyl vinyl ether to the intermediate solution, removing [1,3-bis(2,4,6-trimethylphenyl)-2-imidazoline]dichloro(phenylmethylene)bis(3-bromopyridine))ruthenium(II) by reduced pressure chromatography to obtain a filtrate, concentrating the filtrate under reduced pressure, and adding methanol to the concentrated filtrate to obtain a precipitate as a polymerization product; a reduction step of dissolving the polymerization product in toluene, adding toluenesulfonylhydrazine, and stirring under nitrogen atmosphere to obtain a mixture, heating and refluxing the mixture to obtain a reduction intermediate solution, cooling the reduction intermediate solution with an ice-bath and filtering to remove excess toluenesulfonylhydrazine, performing Soxhlet extraction on the reduction intermediate solution with methanol, and obtaining a reduction product by vacuum drying an extraction product of the Soxhlet extraction; a film forming step of: preparing a 2% (w/v) chlorobenzene solution of the reduction product. Next, adding N,N,N′,N′-tetramethyl-1,3-diaminopropane in an amount equal to 15% of the mole of the terminal bromo group present in the reduction product's structure to create a mixed solution. Filter this mixed solution with a 0.22 m filter, casting the mixed solution on a flat container and heating to obtain a film-shaped product. Soak the film-shaped product in a trimethylamine aqueous solution to perform quaternary ammonium saltation to obtain a quaternary ammonium saltation, resulting in the quaternary ammonium saltation product. Subsequently, soak the quaternary ammonium product in deionized water and vacuum dry the film-shaped product to obtain a cross-linked copolymer in film form; an ion exchange step of: socking the cross-linked copolymer in a 1 M NaOH aqueous solution for 24 hours, and then rinsing the cross-linked copolymer with deionized water to obtain the norbornene-derived copolymer, wherein the polymerization step is performed in a first manner, a second manner or a third manner. The first manner is to simultaneously add and mix the first solution and the second solution to the third solution. The second manner is to sequentially add and mix the first solution and the second solution to the third solution. The third manner is to sequentially add and mix a portion of the first solution, the second solution, and the remaining portion of the first solution to the third solution.

The polymerization product obtained from the polymerization step performed in the first manner is represented by formula 1. The polymerization product obtained from the polymerization step performed in the second manner is represented by formula 2. The polymerization product obtained from the polymerization step performed in the third manner is represented by formula 3.

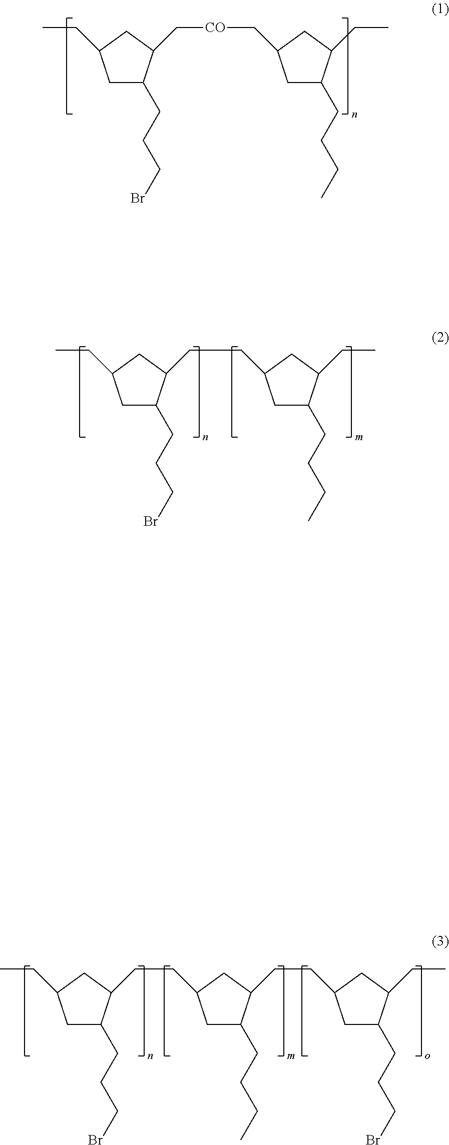

Wherein when the polymerization step is performed in the first manner, the quaternary ammonium saltation product obtained in the film forming step is represented by formula 4. When the polymerization step is performed in the second manner, the quaternary ammonium saltation product obtained in the film forming step is represented by formula 5. When the polymerization step is performed in the third manner, the quaternary ammonium saltation product obtained in the film forming step is represented by formula 6.

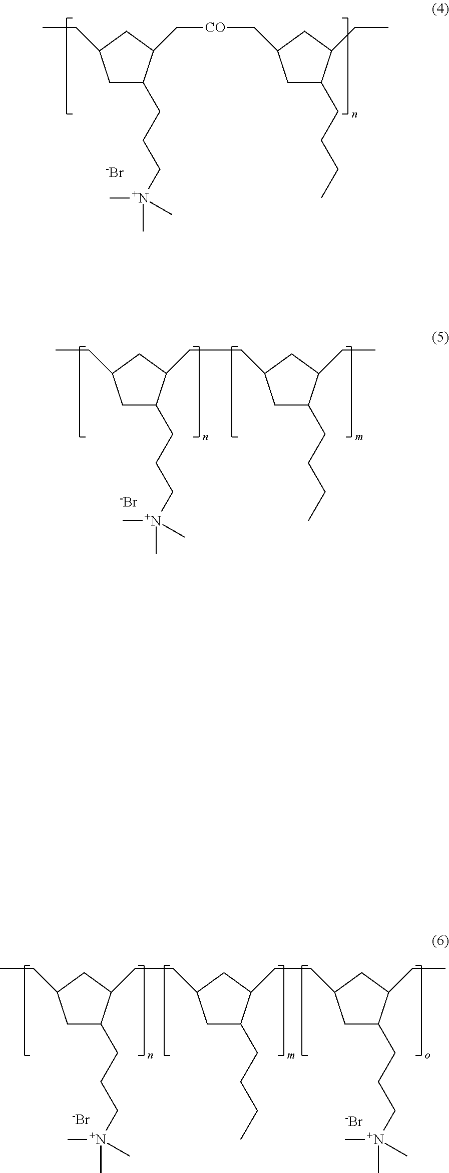

Wherein when the polymerization step is performed in the first manner, the cross-linked copolymer obtained in the film forming step is represented by formula 7. When the polymerization step is performed in the second manner, the cross-linked copolymer obtained in the film forming step is represented by formula 8. When the polymerization step is performed in the third manner, the cross-linked copolymer obtained in the film forming step is represented by formula 9.

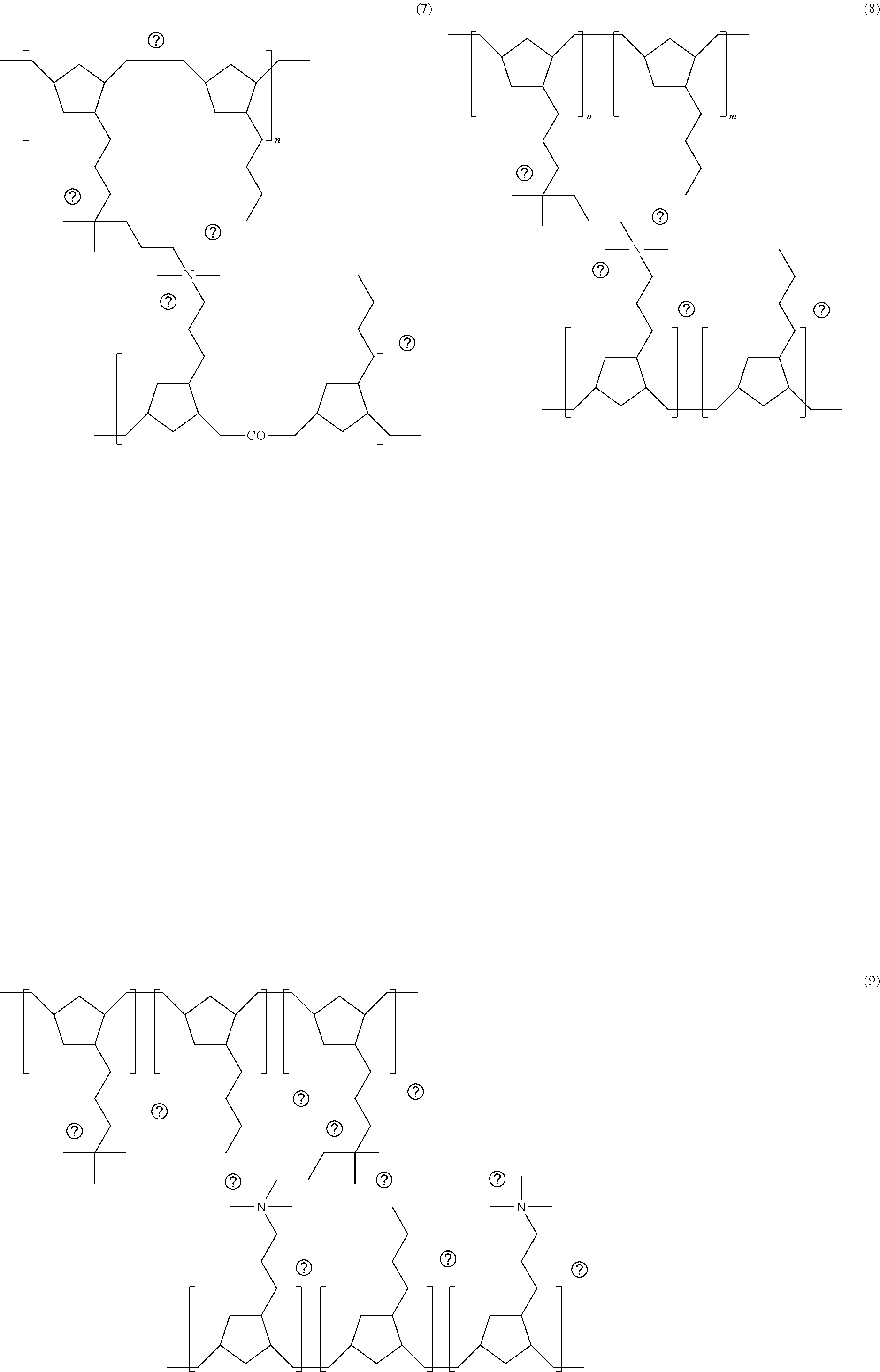

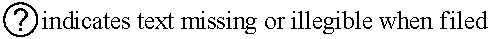

Wherein when the polymerization step is performed in the first manner, the norbornene-derived copolymer obtained in the ion exchange step is represented by formula 10. When the polymerization step is performed in the second manner, the norbornene-derived copolymer obtained in the ion exchange step is represented by formula 11. When the polymerization step is performed in the third manner, the norbornene-derived copolymer obtained in the ion exchange step is represented by formula 12.

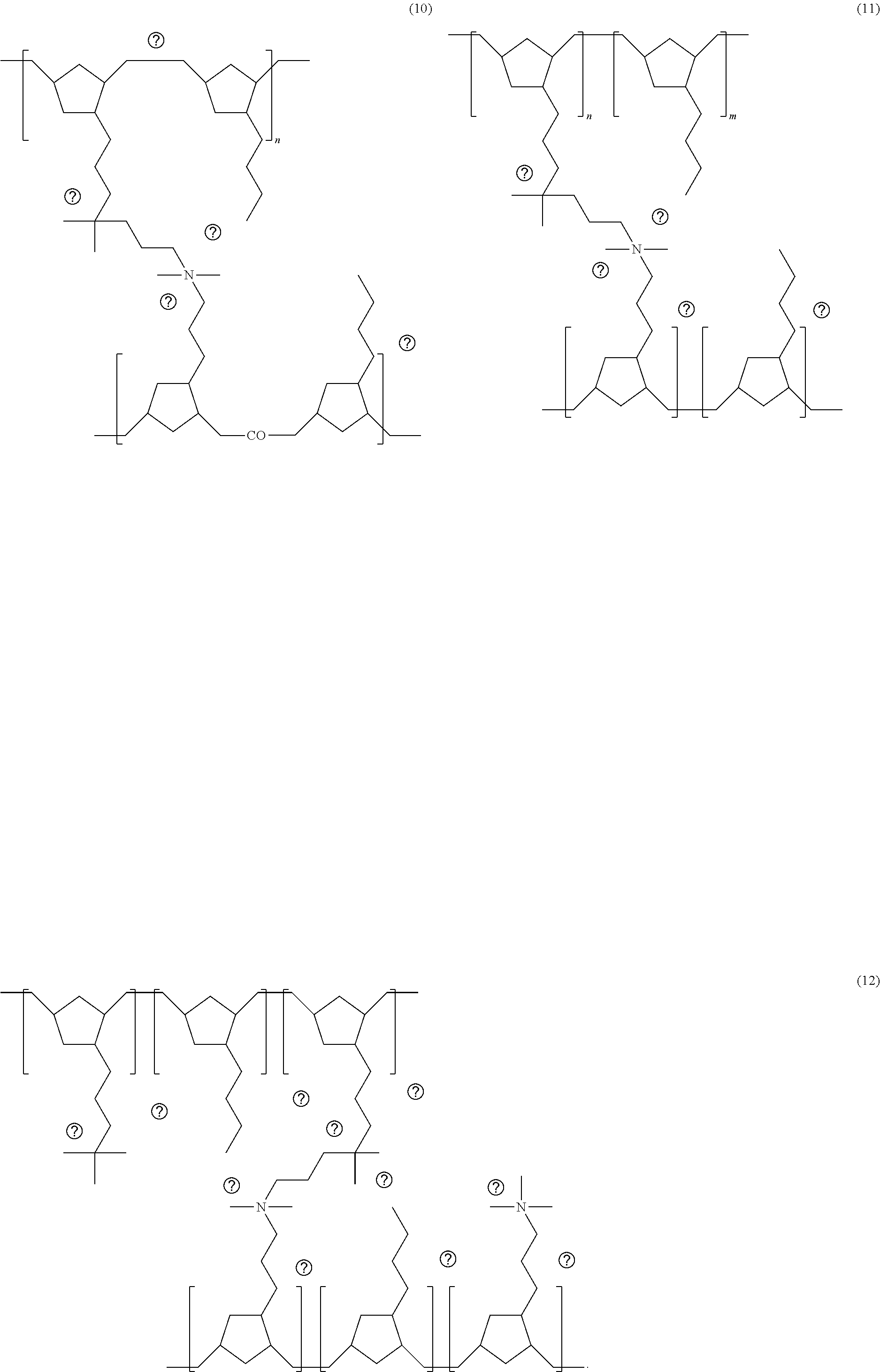

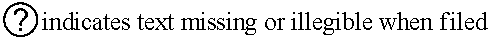

In this embodiment, 2.55 g (19.27 mmol) of dicyclopentadiene (DCPD), 11.07 g (74.28 mmol) of 5-bromo-1-pentene, and 0.003 g (0.02 mmol) of hydroquinone were sequentially added to a 50 mL sealed bottle, and stirred uniformly with a magnetic stirrer under a nitrogen atmosphere for 10 minutes. Then, the reaction temperature was raised to 210° C. and maintained for 24 hours. After the reaction was completed, the solution temperature was lowered to room temperature, excess 5-bromo-1-pentene was removed by vacuum concentration at 70° C., the transparent, colorless crude product was obtained via vacuum distillation at 110° C., and hexane was added to remove impurities by column chromatography, thereby yielding 5-(bromopropyl)bicyclo[2.2.1]hept-2-ene (M1).

In this embodiment, 10.00 g (75.64 mmol) of dicyclopentadiene (DCPD), 19.10 g (226.95 mmol) of 1-hexene, and 0.003 g (0.02 mmol) of hydroquinone were sequentially added to a 150 mL sealed bottle, and stirred uniformly with a magnetic stirrer under a nitrogen atmosphere for 10 minutes. Then, the reaction temperature was raised to 240° C. and maintained for 48 hours. After the reaction was completed, the solution temperature was lowered to room temperature, excess 1-hexene was removed using a pneumatic pump, and finally, 5-butylbicyclo[2.2.1]hept-2-ene (M2) was obtained via vacuum distillation at 70° C.

0.098 g (0.115 mmol) of benzylidene[1,3-bis(2,4,6-trimethylphenyl)-2-imidazolidinylidene]dichloro(tricyclohexylphosphine)ruthenium (G2) and 1 mL of toluene were added to a 20 mL sample vial pre-saturated with nitrogen, then stirred with a magnetic stirrer until G2 was completely dissolved, then 1 mL (10.0 mmol) of 3-bromopyridine was added to the reactor and allowed to react at room temperature for 15 minutes, the reaction mixture was then poured into 50 mL of hexane to precipitate the solid, which was then filtered and washed several times with 5 mL of hexane, and then the solid was vacuum-dried at room temperature to remove hexane, thereby yielding [1,3-bis(2,4,6-trimethylphenyl)-2-imidazolidinylidene]dichloro(phenylmethylene)bis(3-bromopyridine)ruthenium(II) (G3) as the catalyst.

In this embodiment, the ratio of the feed amount of the hydrophilic monomer M1 was controlled to synthesize polymer structures with different ranges of ion exchange capacity (IEC) values and varying block numbers. Specifically, M1 was added at molar fractions of 0.30, 0.40, and 0.50 to synthesize poly(norbornene) high polymers with theoretical IEC values of 1.77, 2.24 and 2.74, respectively. The resulting polymers from this embodiment were named X-rPNB, wherein “X” represents the number of blocks in the copolymer and “r” represents its IEC value.

According to a manufacturing method of a norbornene-derived copolymer in an embodiment of the present invention, in the preparation step, 1.44 mmol of 5-(bromopropyl)bicyclo[2.2.1]hept-2-ene is used to prepare 0.2 M anhydrous dichloromethane solution as the first solution, and 2.20 mmol of 5-butylbicyclo[2.2.1]hept-2-ene is used to prepare 0.2 M anhydrous dichloromethane solution as the second solution.

According to a manufacturing method of a norbornene-derived copolymer in an embodiment of the present invention, the polymerization step is performed under −26° C.

In one example of manufacturing norbornene-derived copolymers using the first manner, 0.31 g (1.44 mmol) of M1 and 0.33 g (2.20 mmol) of M2 were placed in a sample vial to prepare a first and a second solution as 0.2 M anhydrous dichloromethane solutions, and stirred under a nitrogen atmosphere for 10 minutes. Next, 8.00 mg (9.03×10⁻³ mmol) of G3 and 3 mL of anhydrous dichloromethane were weighed to prepare a third solution, which was then added to a 50 mL three-neck round-bottom flask pre-saturated with nitrogen, the reaction temperature was then lowered to −26° C. after stirring the reactant with a magnetic stirrer, the first and second solutions were introduced into the vigorously stirring reactor with a double-ended needle, and then the reaction was allowed to proceed for 90 minutes to obtain an intermediate solution. After the reaction was completed, excess ethyl vinyl ether (1.00 mL, 10.4 mmol) was added to the intermediate solution to stop the polymerization reaction for 20 minutes. The intermediate solution was then introduced into a vacuum chromatography column to remove the catalyst G3 and collect the filtrate, which was concentrated under reduced pressure to 15 mL. Finally, the filtrate was poured into methanol for precipitation, and the resulting product was vacuum-dried at room temperature overnight, yielding 0.61 g of white solid polymer product.

In this embodiment, the resulting products were named R-rPNB, wherein R represents a random copolymer, and r represents the IEC value calculated from the bromine functional groups in the product after quaternization, as determined by nuclear magnetic resonance (NMR) spectroscopy.

In one example of manufacturing norbornene-derived copolymers using the second manner, 0.31 g (1.44 mmol) of M1 and 0.33 g (2.20 mmol) of M2 were placed in a sample vial to prepare the first and second solutions as 0.2 M anhydrous dichloromethane solutions, and stirred under a nitrogen atmosphere for 10 minutes. Next, 8.00 mg (9.03×10⁻³ mmol) of G3 and 3 mL of anhydrous dichloromethane were weighed to prepare a third solution, which was then added to a 50 mL three-neck round-bottom flask pre-saturated with nitrogen, the reaction temperature was then lowered to −26° C. after stirring the reactant with a magnetic stirrer. Then, the first solution was introduced into the reactor with a double-ended needle and reacted for 20 minutes. The second solution was then added, followed by a 30 minutes reaction to obtain an intermediate solution. After the reaction was completed, excess ethyl vinyl ether (1.00 mL, 10.4 mmol) was added to the intermediate solution to stop the polymerization reaction for 20 minutes. The intermediate solution was then introduced into a vacuum chromatography column to remove the catalyst G3 and collect the filtrate, which was concentrated under reduced pressure to 15 mL. Finally, the filtrate was poured into methanol for precipitation, and the resulting product was vacuum-dried at room temperature overnight, yielding 0.61 g of white solid polymer product.

In this embodiment, the resulting products were named D-rPNB, wherein D represents a diblock copolymer, and r represents the IEC value calculated from the bromine functional groups in the product after quaternization, as determined by nuclear magnetic resonance (NMR) spectroscopy.

In one example of manufacturing norbornene-derived copolymers using the third manner, 0.31 g (1.44 mmol) of M1 and 0.33 g (2.20 mmol) of M2 were placed in a sample vial to prepare the first and second solutions as 0.2 M anhydrous dichloromethane solutions, and stirred under a nitrogen atmosphere for 10 minutes. Next, 8.00 mg (9.03×10⁻³ mmol) of G3 and 3 mL of anhydrous dichloromethane were weighed to prepare a third solution, which was then added to a 50 mL three-neck round-bottom flask pre-saturated with nitrogen, the reaction temperature was then lowered to −26° C. after stirring the reactant with a magnetic stirrer. Then part of the first solution was introduced into a vigorously stirred reactor with a double-ended needle and reacting for 20 minutes, then add M2 and react for 30 minutes, and add the remaining M1 and react for 30 minutes reaction to obtain the intermediate solution. After the reaction was completed, excess ethyl vinyl ether (1.00 mL, 10.4 mmol) was added to the intermediate solution to stop the polymerization reaction for 20 minutes. The intermediate solution was then introduced into a vacuum chromatography column to remove the catalyst G3 and collect the filtrate, which was concentrated under reduced pressure to 15 mL. Finally, the filtrate was poured into methanol for precipitation and the resulting product was vacuum-dried at room temperature overnight, yielding 0.61 g of white solid polymer product.

In this embodiment, the resulting products were named T-rPNB, wherein T represents triblock copolymer, and r represents the IEC value calculated from the bromine functional groups in the product after quaternization, as determined by nuclear magnetic resonance (NMR) spectroscopy.

The properties of the polymer products manufactured according to the manufacturing method of the norbornene-derived copolymer of an embodiment of the present invention are shown in Table 1, where n, m, and o represent different repeating units. Based on the molecular structures, the polymer products manufactured by the first, second, and third manners can be categorized into three different products with varying IEC values.

TABLE 1

| | Theoretical value | | | Experimental value | | | Mn (kDa) | | |
|---|---|---|---|---|---|---|---|---|---|
| Polymers | n | m | o | n | m | o | Expected | Actual | PDI |
| R-1.76PNB | 30.0 | 70.0 | 0.0 | 29.9 | 70.1 | 0.0 | 68 | 70 | 1.02 |
| R-2.24PNB | 40.0 | 60.0 | 0.0 | 39.1 | 60.9 | 0.0 | 70 | 67 | 1.02 |
| R-2.74PNB | 50.0 | 50.0 | 0.0 | 49.0 | 51.0 | 0.0 | 73 | 71 | 1.02 |
| D-1.76PNB | 30.0 | 70.0 | 0.0 | 29.6 | 70.4 | 0.0 | 68 | 70 | 1.01 |
| D-2.24PNB | 40.0 | 60.0 | 0.0 | 41.2 | 58.8 | 0.0 | 70 | 69 | 1.02 |
| D-2.74PNB | 50.0 | 50.0 | 0.0 | 49.3 | 50.7 | 0.0 | 73 | 71 | 1.03 |
| T-1.76PNB | 15.0 | 70.0 | 15.0 | 14.8 | 70.4 | 14.8 | 68 | 68 | 1.01 |
| T-2.24PNB | 20.0 | 60.0 | 20.0 | 19.9 | 60.2 | 19.9 | 70 | 73 | 1.02 |
| T-2.74PNB | 25.0 | 50.0 | 25.0 | 24.8 | 50.4 | 24.8 | 73 | 74 | 1.01 |

From Table 1, it can be seen that the polymer products manufactured according to the manufacturing method of the norbornene-derived copolymer of the present invention have a PDI value very close to 1, indicating that their molecular weight distribution range is very small.

Further, reduction step was performed to reduce the norbornene-derived copolymer.

The current methods for reducing poly-norbornene can be mainly divided into two approaches: using metal catalysts and decomposing p-toluenesulfonyl hydrazide (TSH). In this embodiment, TSH is select for the reduction reaction, the polymer product was dissolved in toluene, then TSH was added while stirring under a nitrogen atmosphere, and the resulting mixture is heated for reflux to obtain a reduced intermediate solution. The reduced intermediate solution in was subjected to an ice bath and filtered to remove excess TSH. The reduced intermediate solution was then extracted with methanol in a Soxhlet extractor, and the product from the Soxhlet extraction is vacuum-dried to obtain the reduced product.

TSH-derived diazene is a very effective reducing agent, capable of almost completely saturating double bonds in the structure under favorable conditions, and TSH has the advantage of allowing reactions to occur without the need for high pressure.

The properties of the reduced product after the reduction step are shown in Table 2, wherein HPNB represents the hydrogenated PNB.

TABLE 2

| | Theoretical value | | | Experimental value | | | Mn (kDa) | | |
|---|---|---|---|---|---|---|---|---|---|
| Polymers | n | m | o | n | m | o | Expected | Actual | PDI |
| R-1.66HPNB | 29.9 | 70.1 | 0.0 | 28.2 | 71.8 | 0.0 | 70 | 73 | 1.03 |
| R-2.15HPNB | 39.1 | 60.9 | 0.0 | 37.8 | 62.2 | 0.0 | 71 | 72 | 1.02 |
| R-2.58HPNB | 49.0 | 51.0 | 0.0 | 46.6 | 53.4 | 0.0 | 71 | 74 | 1.05 |
| D-1.52HPNB | 29.6 | 70.4 | 0.0 | 25.6 | 74.4 | 0.0 | 70 | 69 | 1.06 |
| D-2.00HPNB | 41.2 | 58.8 | 0.0 | 34.9 | 65.1 | 0.0 | 69 | 70 | 1.03 |
| D-2.47HPNB | 49.3 | 50.7 | 0.0 | 44.4 | 55.6 | 0.0 | 71 | 73 | 1.03 |
| T-1.60HPNB | 14.8 | 70.4 | 14.8 | 13.5 | 73 | 13.5 | 68 | 68 | 1.03 |
| T-1.97HPNB | 19.9 | 60.2 | 19.9 | 17.1 | 65.8 | 17.1 | 73 | 68 | 1.07 |
| T-2.44HPNB | 24.8 | 50.4 | 24.8 | 21.9 | 56.2 | 21.9 | 74 | 71 | 1.05 |

From Table 2, it can be seen that the molecular weight of the polymers before and after reduction does not change significantly, PDI shows an upward trend, but still remains in a low range (PDI≤1.1), and due to structural changes, the IEC value generally decreases.

Next, the film forming step was performed, wherein the reduced product described above was dissolved in chlorobenzene to prepare a 2% (w/v) solution, a crosslinking agent, N,N,N′,N′-tetramethyl-1,3-diaminopropane was added in an amount of 15% of the molar number of the terminal bromo group contained in the structure of the reduction product to obtain a mixed solution. After stirring at room temperature for 10 minutes, the mixed solution was filtered with a 0.22 m filter. Then, the poly(norbornene) solution was cast onto a glass petri dish and heated in a circulating oven at 60° C. for 18 hours to remove a portion of the solvent. The temperature was then increased to 130° C. for 2 hours to ensure complete removal of the solvent. Afterward, the film was taken out and soaked in a 30 wt % triethylamine aqueous solution, with the triethylamine solution replaced every 24 hours, and placed at room temperature for 48 hours to undergo polymer modification. After the reaction was completed, the film was taken out and soaked in deionized water for 24 hours, with the deionized water replaced every 8 hours to remove excess trimethylamine solution, and then after vacuum drying at 80° C., a yellow film was obtained. In this embodiment, the cross-linked copolymer in film form is designated by adding CL15 before the name of the reduced product used as the raw material, indicating that it has undergone crosslinking treatment.

Further, ion exchange step was performed: the crosslinked copolymer was soaked in a 1 M NaOH aqueous solution for 24 hours and rinsed with deionized water to obtain the norbornene-derived anion exchange membrane.

This norbornene-derived copolymer film was used as an anion exchange membrane to measure its ion exchange capacities (IEC), water uptake (WU), swelling ratio (SR), and thermal properties.

When measuring the IEC value, the molar number of cationic groups in each anion exchange membrane is calculated with NMR spectra, the completely ion-exchanged film is placed in a ultrapure water sample bottle for one day, then 3 equivalents of hydrochloric acid (HCl) based on the mole of cationic groups were added. The mixture is then placed in an ultrasonic bath for one day, and then the titration is performed with an automatic titrator (888 Titrando, Metrohm) with a sodium hydroxide (NaOH) solution of known concentration. The IEC values for each anion exchange membrane are calculated with the formula:

$$IEC ( mmol / g ) = ( {C}_{HCI} \times {V}_{HCI} - {C}_{NaOH} \times {V}_{NaOH} ) / M ,$$

wherein C_{HCl} is the molar concentration of HCl; V_{HCl} is the volume of HCl; C_{NaOH} is the molar concentration of NaOH; V_{NaOH} is the volume of NaOH; and M is the weight of the polymer film when dry.

The measurements of water uptake (WU) and swelling ratio (SR) were conducted as follows: the completely ion-exchanged anion exchange membrane was rinsed with ultrapure water pre-saturated with nitrogen until neutral, then the surface moisture is wiped off to weigh the wet film weight and measure its length and thickness, and then the film was placed in a vacuum oven at 80° C. for 24 hours, after opening the oven, the dry film weight is immediately measured along with its length and thickness. The water uptake and swelling ratio for each anion exchange membrane are calculated with the formulas provided below, with the calculated values presented in Table 3.

$$WU = ( {M}_{wet} - {M}_{dry} ) / {M}_{dry} \times 100 \%$$

$$LC = ( {L}_{wet} - {L}_{dry} ) / {L}_{dry} \times 100 \%$$

$$TC = ( {T}_{wet} - {T}_{dry} ) / {T}_{dry} \times 100 \%$$

where M_{wet} is the weight of the wet film, M_{dry} is the weight of the dry film. L_{wet} is the length of the wet film, L_{dry} is the length of the dry film. T_{wet} is the thickness of the wet film, T_{dry} is the thickness of the dry film. LC is the swelling ratio in the length direction, and TC is the swelling ratio in the thickness direction.

The thermal properties were measured with a thermogravimetric analyzer (TGA) on the dry film in the bromide ion form. To ensure the accuracy of weight loss measurements, the dry film was placed in a nitrogen environment at 130° C. for 15 minutes to remove moisture that has been adsorbed from the environment. After the drying procedure has completed, the temperature was dropped to room temperature, and the film was heated from room temperature to 600° C. at a heating rate of 10° C./min in a nitrogen environment so that the weight loss during the heating process was measured. By analyzing the temperature and weight changes of the dry film, the degradation behavior of the sample and the temperature at which degradation begins can be determined. The results are presented in Table 3.

The measurement of the glass transition temperature was conducted with a dynamic mechanical analyzer (DMA). The film was cut into pieces measuring 5 cm×0.5 cm, with a thickness of approximately 100˜150 m, and measurements were taken in the dry film (Br⁻ form). In a nitrogen environment, the temperature is raised from −20° C. to 190° C. at a heating rate of 3° C./min, and the thermal energy changes were observed. The measurement results are presented in Table 3.

TABLE 3

| | IEC_{tit..} | WU | LC/TC | T_{d 5%} | T_{g} |
|---|---|---|---|---|---|
| Polymer | (mmol/g) | (%) | (%) | (° C.) | (° C.) |
| R-1.66HPNB | 1.60 | 526 | 53.0/65.2 | 232 | 49~ |
| R-2.15HPNB | 1.92 | 599 | 55.9/85 | 240 | 45~ |
| R-2.58HPNB | 2.64 | 675 | — | — | — |
| CL15-R-2.58HPNB | 2.54 | 547 | 69.8/99.0 | 250 | 32/131 |
| D-1.52HPNB | 1.50 | 102 | 20.1/29.0 | 256 | 34/173 |
| D-2.00HPNB | 2.07 | 194 | 22.5/53.6 | 258 | 28/159 |
| D-2.47HPNB | 2.55 | 393 | 45.9/114.5 | 252 | 26/168 |
| CL15-D-2.47HPNB | 2.50 | 280 | 50.0/45.4 | 255 | 23/161 |
| T-1.60HPNB | 1.48 | 91 | 16.5/25.5 | 256 | 26/162 |
| T-1.97HPNB | 2.17 | 200 | 25.6/57.7 | 257 | 28/156 |
| T-2.44HPNB | 2.40 | 422 | 48.6/109.6 | 253 | 29/161 |
| CL15-T-2.44HPNB | 2.53 | 270 | 46.0/50.2 | 248 | 26/175 |

In Table 3, it can be seen that the IEC(tit) value of the norbornene-derived copolymer anion exchange membrane produced by the manufacturing method of an embodiment of the present invention, the results were similar to the IEC value calculated with NMR. This indicates that the quaternization of the bromine functional groups in the polymer is complete.

From Table 3, it can be seen that the water content and swelling ratio of the anion exchange membrane manufactured by the manufacturing method of an embodiment of the present invention show a noticeable increase with the rise in IEC. In particular, R−2.58HPNB has an extremely high water content, resulting in poor mechanical properties and dimensional stability, making it impossible to measure subsequent values. Although it still has a high water content after crosslinking, but its subsequent properties can be measured. The D−2.47HPNB and T−2.44HPNB, which have similar IEC values, both exhibit lower water content and better dimensional stability compared to R−2.58HPNB, indicating that block copolymers perform better than random copolymers in controlling water content and dimensional stability. On the other hand, compared to known techniques, the anion exchange membrane synthesized in this embodiment exhibits higher water content than other common backbone structures of anion exchange membranes.

The thermogravimetric analysis results of the anion exchange membranes produced from norbornene-derived copolymers, as described in an embodiment of the present invention, indicate that their decomposition temperature is approximately 500° C. This temperature is adequate to support the operating range of 50 to 80° C. for anion exchange membrane fuel cells (AEMFC), which primarily function at low temperatures.

From Table 3, it is evident that the glass transition temperature (Tg) of the anion exchange membrane, produced from a norbornene-derived copolymer using the manufacturing method described in an embodiment of the present invention, demonstrates that both diblock and triblock copolymers exhibit distinct glass transition signals near 30° C. and 160° C. This observation indicates the presence of two different blocks within the polymer, suggesting phase separation. In contrast, the random copolymer shows a noticeable glass transition signal at only one temperature, indicating that diblock and triblock copolymers are more suitable for the manufacture of anion exchange membranes compared to random copolymers.

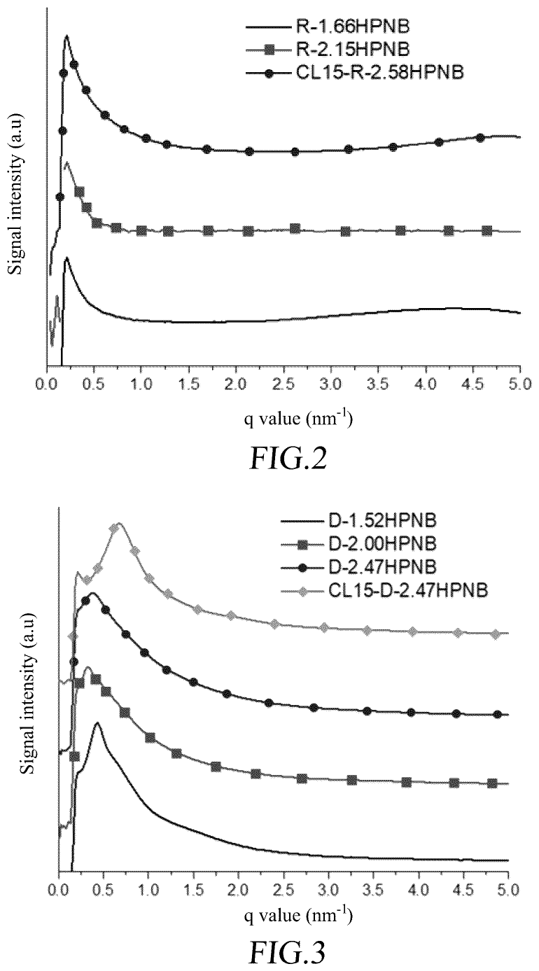

FIGS. 2 to 4 show the small-angle X-ray scattering (SAXS) spectra for the first manner, second manner, and third manner, respectively.

From FIGS. 2 to 4, it can be seen that the anion exchange membrane manufactured by the first manner shows no signals in the SAXS spectrum, indicating that the polymers in the anion exchange membranes are not arranged in an ordered manner. In contrast, the anion exchange membranes manufactured by the second and third manners exhibit observable signals, indicating that they have significant phase separation, further confirming their phase separation characteristics.

Further, it can be seen form the figures that the q values measured for CL15-T-2.74HPNB exhibit a 1:2:3 pattern, suggesting that it possesses a one-dimensional stacked lamellae structure, comparing this with the figures and Table 5, the structures with phase separation demonstrate better conductivity.

FIG. 5 shows the transmission electron microscopy (TEM) observations result of the anion exchange membrane manufactured by the third manner of the manufacturing method of the norbornene-derived copolymer according to another embodiment of the present invention. The membrane exhibits a distinct one-dimensional lamellae structure, which is consistent with the measurements obtained from SAXS.

Furthermore, the manufactured anion exchange membrane is tested for ion conductivity and alkaline stability

In this embodiment, a two-point electrochemical impedance spectroscopy (EIS) was used to measure the ionic conductivity of the anion exchange membrane, the changes in current frequency were observed to measure the anion conductivity resistance value (R, Q) by applied high-frequency alternating current and subjecting the electrodes to high and low voltages.

First, the completely hydroxide ion-exchanged anion exchange membrane was taken out from the ultrapure water pre-saturated with nitrogen and fixed onto the electrodes. The electrodes were then placed in a nitrogen-purged temperature and humidity-controlled oven (98% RH) for measurement, with the measurement temperatures set sequentially at 80, 60, 45, and 30° C., the overall environment was allowed to equilibrate for one hour before measurements begin. The ion conductivity is calculated using the formula as follows, and the results are presented in Table 4.

$$σ ( S / cm ) = d / wtR$$

wherein d is the electrode gap, w is the width of the anion exchange membrane, t is the thickness of the anion exchange membrane, and R is the impedance value measured by EIS.

TABLE 4

| Anion exchange | Ea | Anion conductivity (mS/cm) | | | |
|---|---|---|---|---|---|
| membrane | (KJ/mol) | 30° C. | 45° C. | 60° C. | 80° C. |
| R-1.66HPNB | 2.09 | 39.58 | 59.35 | 85.69 | 103.24 |
| R-2.15HPNB | 2.24 | 57.08 | 89.82 | 124.18 | 162.92 |
| CL15-R-2.58HPNB | 2.71 | 86.40 | 136.18 | 215.17 | 300.97 |
| D-1.52HPNB | 2.27 | 30.35 | 43.06 | 58.92 | 87.63 |
| D-2.00HPNB | 2.99 | 49.63 | 78.37 | 124.08 | 198.53 |
| D-2.47HPNB | 3.11 | 53.34 | 89.28 | 139.58 | 227.65 |
| CL15-D-2.47HPNB | 2.76 | 49.52 | 78.08 | 117.62 | 178.71 |
| T-1.60HPNB | 1.65 | 42.83 | 49.85 | 63.32 | 91.98 |
| T-1.97HPNB | 2.05 | 51.93 | 74.70 | 101.06 | 134.86 |
| T-2.44HPNB | 2.97 | 56.06 | 87.74 | 133.38 | 224.23 |
| CL15-T-2.44HPNB | 2.93 | 51.40 | 82.55 | 121.07 | 204.31 |

As shown in Table 4, the anion exchange membrane manufactured from random copolymers generally exhibit higher conductivity compared to the anion exchange membranes from block copolymers with similar IEC values, this can be attributed to their high water uptake.

However, the high water uptake leads to poor mechanical properties, making them less suitable for practical use as anion exchange membranes. In contrast, the anion exchange membranes made from diblock and triblock copolymers show that as the IEC increases, the conductivity also rises. Notably, D−2.47HPNB and T−2.44HPNB achieve high values of 227.65 mS/cm and 224.23 mS/cm at 80° C., respectively, and maintain good conductivity after crosslinking, while also exhibiting better mechanical properties, making them suitable for practical applications as anion exchange membranes.

Regarding the alkaline stability of the anion exchange membrane as described in the embodiment of the present invention, it is essential to note that the membrane must function in an alkaline environment for prolonged periods. Quaternary ammonium is susceptible to attack by hydroxide ions, which can result in structural degradation. This degradation indirectly impacts properties such as ion conductivity and mechanical strength. Therefore, alkaline stability is an important indicator for assessing the lifespan of anion exchange membranes.

The measurement of alkaline stability involves placing the completely ion-exchanged anion exchange membrane into a sealed container with 1 M NaOH solution pre-purged with nitrogen at a temperature of 60° C. The NaOH solution was changed every two days, and periodically, the membrane is taken out, rinsed with ultrapure water until neutral, and its ion conductivity is measured with the aforementioned method to observe changes in properties relative to the soaking time. The measurement results are presented in Table 5.

TABLE 5

| Anion exchange | | | | | | loss rate |
|---|---|---|---|---|---|---|
| membrane | σ | 144 h | 288 h | 432 h | 720 h | (%) |
| R-1.66HPNB | 103.24 | 91.70 | 101.47 | 94.26 | 91.43 | 11.43 |
| R-2.15HPNB | 162.92 | 152.94 | 152.63 | 139.55 | 132.64 | 18.59 |
| CL15-R-2.58HPNB | 300.97 | — | — | — | — | — |
| D-1.52HPNB | 87.63 | 106.49 | 91.23 | 89.98 | 81.78 | 6.68 |
| D-2.00HPNB | 198.53 | 193.88 | 194.89 | 190.41 | 186.96 | 5.83 |
| D-2.47HPNB | 227.65 | 225.68 | 220.13 | 203.08 | 211.49 | 7.10 |
| CL15-D-2.47HPNB | 178.71 | 185.54 | 183.98 | 175.14 | 174.27 | 2.48 |
| T-1.60HPNB | 91.98 | 97.64 | 91.90 | 94.30 | 83.03 | 9.73 |
| T-1.97HPNB | 134.86 | 133.66 | 132.75 | 135.24 | 130.14 | 3.50 |
| T-2.44HPNB | 224.23 | 226.78 | 214.51 | 209.97 | 204.99 | 8.58 |
| CL15-T-2.44HPNB | 204.31 | 200.29 | 196.92 | 175.14 | 180.32 | 11.74 |

According to table 5, it can be observed that the anion exchange membranes according to the embodiment of the present invention show a reduction in conductivity of less than 20% after 720 hours of extended testing. Notably, the degradation rate of the anion exchange membranes with block copolymers as the main structure is only about 10%, this is likely due to the molecular structure, which separates the polymer backbone and quaternary ammonium functional groups with long carbon chains, the spatial hindrance provided by these long carbon chains can impede the attack of hydroxide ions, reducing the likelihood of Hofmann elimination and enhancing the alkaline stability of the membrane.

The performance testing of the anion exchange membranes according to the embodiment of the present invention is primarily compared with the existing chemical and electrochemical properties of poly (norbornene)s produced via ring opening metathesis polymerization, the results are summarized in Table 6.

TABLE 6

| Cationic poly- | Conductivity at 50° | |
|---|---|---|
| norbornene | C. | Alkaline stability |
| The second manner | ~90 mS/cm | Soaking in a 1 molar volume concentration |
| of present | | of sodium hydroxide solution at 60° C. for |
| embodiment | | 30 days resulted in a conductivity decline |
| (CL15-D-2.47HPNB) | | of 2.48%. |
| The third manner of | ~95 mS/cm | Soaking in a 1 molar volume concentration |
| present embodiment | | of sodium hydroxide solution at 60° C. for |
| (CL15-T-2.44HPNB) | | 30 days resulted in a conductivity decline |
| | | of 11.74%. |
| Comparative | ~55 mS/cm | Soaking in a 1 molar volume concentration |
| Example | | of sodium hydroxide solution at 60° C. for |
| (Bisimidazolium salt | | 21 days resulted in a conductivity decline |
| exchange membrane) | | of 31-50%. |
| Comparative | ~30 mS/cm | Soaking in a 1 molar volume concentration |
| Example | | of sodium hydroxide solution at 60° C. for |
| (Epoxy resin | | 10 days resulted in a conductivity decline |
| crosslinked | | of 13-15%. |
| imidazolium salt | | |
| exchange membrane) | | |
| Comparative | ~100 mS/cm | Not tested. |
| Example | | |
| (Nadic amide-based | | |
| quaternary | | |
| ammonium salt | | |
| exchange membrane) | | |

From Table 6, it can be seen that the anion exchange membranes according to the embodiment of the present invention exhibit excellent conductivity and have better alkaline stability compared to the known technology.

Another embodiment of the present invention provides a method for using the norbornene-derived copolymer as describe above, wherein the norbornene-derived copolymer is used in the field of anion exchange membrane water electrolysis as an anion exchange membrane.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A manufacturing method of a norbornene-derived copolymer, comprising:
a preparation step of preparing an anhydrous dichloromethane solution of 5-(bromopropyl)bicyclo[2.2.1]hept-2-ene as a first solution, an anhydrous dichloromethane solution of 5-butylbicyclo[2.2.1]hept-2-ene as a second solution and an anhydrous dichloromethane solution of [1,3-bis(2,4,6-trimethylphenyl)-2-imidazoline]dichloro(phenylmethylene)bis(3-bromopyridine))ruthenium(II) as a third solution;
a polymerization step of mixing the first solution, the second solution and the third solution at an active polymerization temperature and under a nitrogen atmosphere to cause a polymerization reaction, thereby obtaining an intermediate solution;
a precipitation step of:
adding ethyl vinyl ether to the intermediate solution, removing [1,3-bis(2,4,6-trimethylphenyl)-2-imidazoline]dichloro(phenylmethylene)bis(3-bromopyridine))ruthenium(II) by reduced pressure chromatography to obtain a filtrate, concentrating the filtrate under reduced pressure, and adding methanol to the concentrated filtrate to obtain a precipitate as a polymerization product;
a reduction step of:
dissolving the polymerization product in toluene, adding toluenesulfonylhydrazine, and stirring under nitrogen atmosphere to obtain a mixture, heating and refluxing the mixture to obtain a reduction intermediate solution, cooling the reduction intermediate solution with an ice-bath and filtering to remove excess toluenesulfonylhydrazine, performing Soxhlet extraction on the reduction intermediate solution with methanol, and obtaining a reduction product by vacuum drying an extraction product of the Soxhlet extraction;
a film forming step of:
preparing a 2% (w/v) chlorobenzene solution of the reduction product, adding N,N,N′,N′-tetramethyl-1,3-diaminopropane in an amount of 15% of the molar number of the terminal bromo group contained in the structure of the reduction product to obtain a mixed solution, filtering the mixed solution with a 0.22 μm filter, casting the mixed solution on a flat container and heating to obtain a film-shaped product, and soaking the film-shaped product in a trimethylamine aqueous solution to performing quaternary ammonium saltation to obtain a quaternary ammonium saltation product, soaking the quaternary ammonium saltation product in deionized water, and vacuum drying the film-shaped product to obtain a cross-linked copolymer with film-shape;
an ion exchange step of
socking the cross-linked copolymer in a 1M NaOH aqueous solution for 24 hours, and then rinsing the cross-linked copolymer with deionized water to obtain the norbornene-derived copolymer,
wherein the polymerization step is performed in a first manner, a second manner or a third manner,
the first manner is to simultaneously add and mix the first solution and the second solution to the third solution,
the second manner is to sequentially add and mix the first solution and the second solution to the third solution,
the third manner is to sequentially add and mix a portion of the first solution, the second solution, and the remaining portion of the first solution to the third solution,
wherein the polymerization product obtained from the polymerization step performed in the first manner is represented by formula 1,
the polymerization product obtained from the polymerization step performed in the second manner is represented by formula 2,
the polymerization product obtained from the polymerization step performed in the third manner is represented by formula 3, 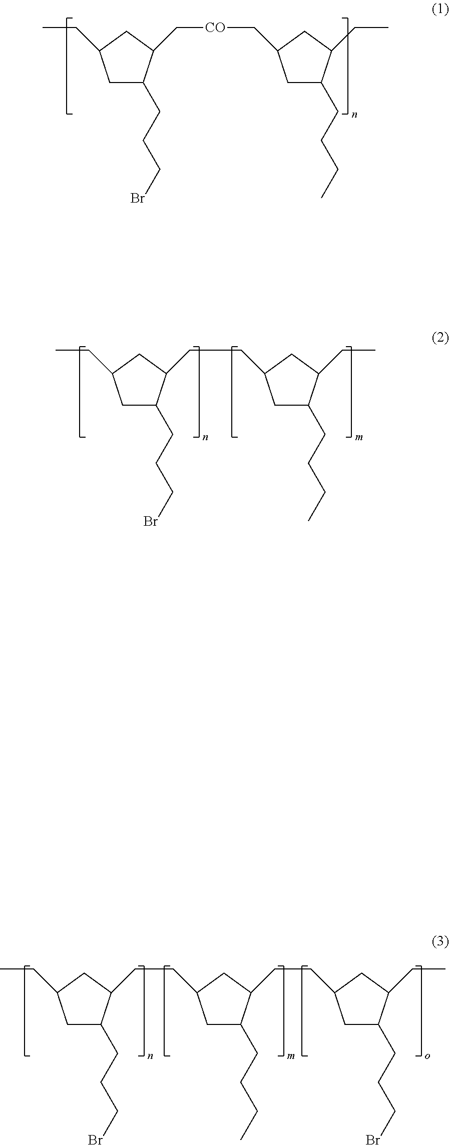
wherein when the polymerization step is performed in the first manner, the quaternary ammonium saltation product obtained in the film forming step is represented by formula 4,
when the polymerization step is performed in the second manner, the quaternary ammonium saltation product obtained in the film forming step is represented by formula 5,
when the polymerization step is performed in the third manner, the quaternary ammonium saltation product obtained in the film forming step is represented by formula 6, 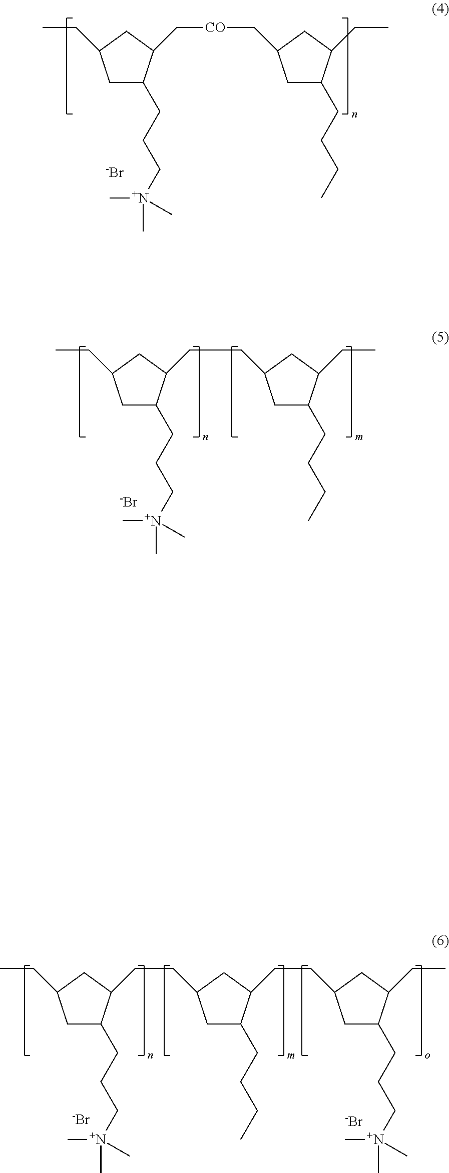
wherein when the polymerization step is performed in the first manner, the cross-linked copolymer obtained in the film forming step is represented by formula 7,
when the polymerization step is performed in the second manner, the cross-linked copolymer obtained in the film forming step is represented by formula 8,
when the polymerization step is performed in the third manner, the cross-linked copolymer obtained in the film forming step is represented by formula 9, 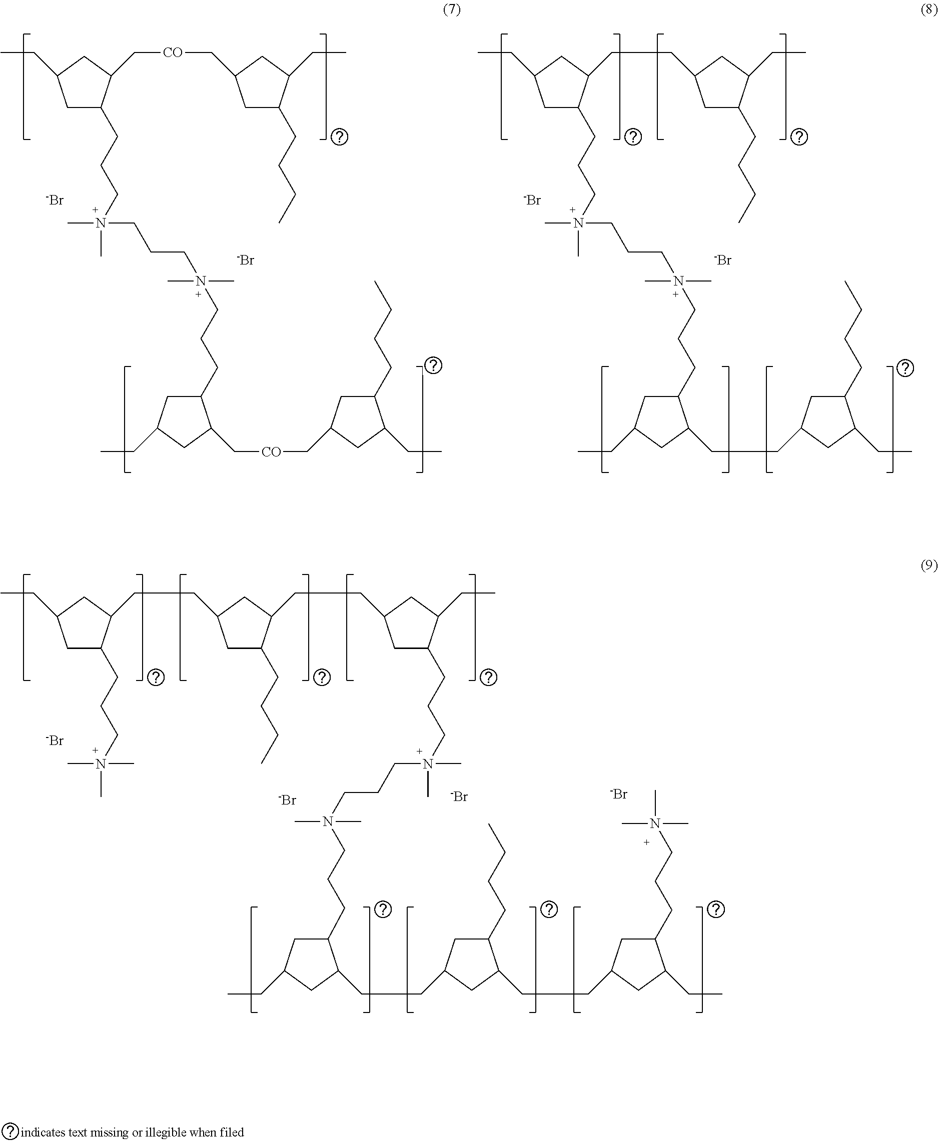
wherein when the polymerization step is performed in the first manner, the norbornene-derived copolymer obtained in the ion exchange step is represented by formula 10,
when the polymerization step is performed in the second manner, the norbornene-derived copolymer obtained in the ion exchange step is represented by formula 11,
when the polymerization step is performed in the third manner, the norbornene-derived copolymer obtained in the ion exchange step is represented by formula 12

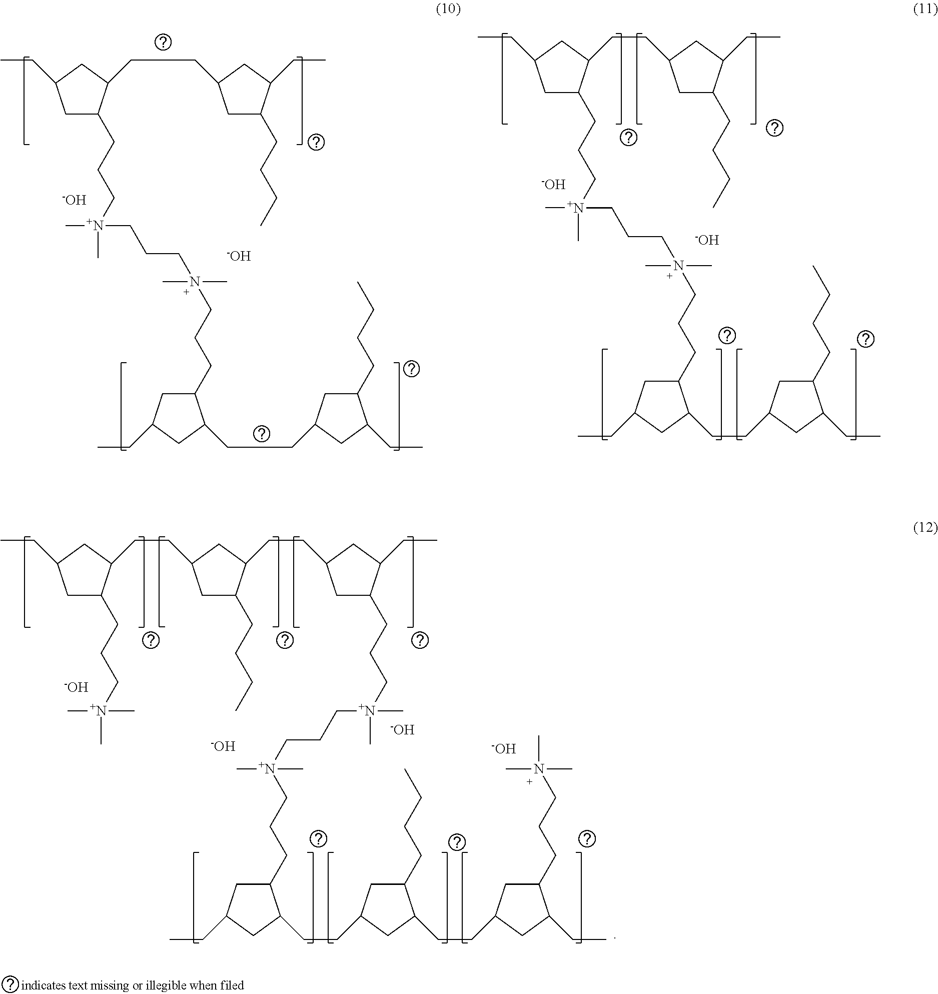

2. The manufacturing method as claimed in claim 1, wherein in the preparation step, 1.44 mmol of 5-(bromopropyl)bicyclo[2.2.1]hept-2-ene is used to prepare 0.2 M anhydrous dichloromethane solution as the first solution, and 2.20 mmol of 5-butylbicyclo[2.2.1]hept-2-ene is used to prepare 0.2 M anhydrous dichloromethane solution as the second solution.

3. The manufacturing method as claimed in claim 1, wherein the polymerization step is performed under −26° C.

4. The manufacturing method as claimed in claim 1, wherein in the third manner, the portion of the first solution and the remaining portion of the first solution added and mixed to the third solution are of equal amounts.

5. A norbornene-derived copolymer manufactured by the manufacturing method as claimed in claim 1.

6. A method for using the norbornene-derived copolymer as claimed in claim 5, wherein the norbornene-derived copolymer is used in the field of anion exchange membrane water electrolysis as an anion exchange membrane.
